(19) United States
(12) Patent Application Publication
(10) Pub. No.: US 2026/0288322 A1
(43) Pub. Date: Sep. 24, 2026

(54) DATA PROCESSING METHOD, APPARATUS AND DEVICE, AND STORAGE MEDIUM

(71) Applicant: Beijing Zitiao Network Technology Co., Ltd., Beijing (CN)

(72) Inventors: Lan LIU, Beijing (CN); Xinjuan WANG, Beijing (CN); Shuo WANG, Beijing (CN)

(21) Appl. No.: 19/148,287

(22) PCT Filed: May 24, 2024
(86) PCT No.: PCT/CN2024/095117

§ 371 Date: Jul. 15, 2025

(30) Foreign Application Priority Data
Jun. 7, 2023 (CN) 202310673807.0

(51) Int. Cl. G06F 3/04847; G06F 3/0482; G06F 3/0483; G06F 16/435

(52) U.S. Cl. CPC G06F 3/04847; G06F 3/0482; G06F 3/0483; G06F 16/435

(57) ABSTRACT

The present disclosure provides a data processing method, apparatus, and device, and a storage medium. The method includes: displaying, on a first page, a media resource object and a recommendation adjustment control corresponding to the media resource object, where the media resource object is used for reflecting a recommended content type, and the media resource object comprises an image or a video segment belonging to the recommended content type; and determining, in response to a trigger operation on a recommendation adjustment control corresponding to a first target media resource object, a recommendation adjustment manner for a recommended content type reflected by the first target media resource object, where the recommendation adjustment manner is used for adjusting a recommendation amount for media content of the recommended content type.

### CROSS-REFERENCE TO RELATED APPLICATION(S)

This application claims priority to Chinese Patent Application No. 202310673807.0, filed with the China National Intellectual Property Administration on Jun. 7, 2023, and entitled “DATA PROCESSING METHOD, APPARATUS, AND DEVICE, AND STORAGE MEDIUM”, the disclosure of which is incorporated herein by reference in its entirety.

### FIELD

The present disclosure relates to the field of data processing, and in particular, to a data processing method, apparatus, and device, and a storage medium.

### BACKGROUND

With the development of the Internet technologies, content recommendation functions have been widely used in various applications.

In the content recommendation functions involved in the current applications, a user selects a recommended content type of interest through a content tag in the form of text, and a content recommendation system recommends media content to the user based on the selected recommended content type. However, the current functions related to content recommendation cannot well meet the increasing content recommendation demands of users.

### SUMMARY

To solve the technical problem described above, an embodiment of the present disclosure provides a data processing method.

According to a first aspect, the present disclosure provides a data processing method. The method includes:
displaying, on a first page, a media resource object and a recommendation adjustment control corresponding to the media resource object, where the media resource object is used for reflecting a recommended content type, and the media resource object includes an image or a video segment belonging to the recommended content type; and
determining, in response to a trigger operation on a recommendation adjustment control corresponding to a first target media resource object, a recommendation adjustment manner for a recommended content type reflected by the first target media resource object, where the recommendation adjustment manner is used for adjusting a recommendation amount for media content of the recommended content type.

In an optional implementation, the method further includes:
playing a first video corresponding to a second target media resource object within a video playback window on a second page in response to a trigger operation on the second target media resource object, where the second target media resource object is an image or a video segment determined from the first video.

In an optional implementation, the method further includes:
displaying, on the second page, a recommendation adjustment control corresponding to the second target media resource object; and
determining, in response to a trigger operation on a recommendation adjustment control corresponding to the second target media resource object, a recommendation adjustment manner for a recommended content type reflected by the second target media resource object.

In an optional implementation, the method further includes:
displaying, on the second page, a video cover of the first video and video covers of a plurality of second videos, where the plurality of second videos belong to the recommended content type reflected by the second target media resource object; and
playing a target video of the plurality of second videos within the video playback window on the second page in response to a trigger operation on a video cover of the target video.

In an optional implementation, the displaying, on a first page, a media resource object and a recommendation adjustment control corresponding to the media resource object includes:
displaying a media resource object list on the first page, where the media resource object list includes a plurality of media resource objects, the plurality of media resource objects respectively have corresponding recommendation adjustment controls, and the media resource list supports sliding display of the plurality of media resource objects.

In an optional implementation, a display position of the media resource object in the media resource object list is determined based on a degree of association between a recommended content type reflected by the media resource object and an interest tag of a current user.

In an optional implementation, the plurality of media resource objects include a first media resource object and a second media resource object, and the displaying a media resource object list on the first page includes:
displaying, on the first page, a partial image of the first media resource object and an entire image of the second media resource object.

In an optional implementation, after the determining a recommendation adjustment manner for a recommended content type reflected by the first target media resource object, the method further includes:
obtaining a first media content recommendation stream in response to a display trigger operation on a media content recommendation page, where the first media content recommendation stream is recommended based on an updated recommendation strategy, and the updated recommendation strategy is updated by using the recommendation adjustment manner for the recommended content type reflected by the first target media resource object; and
playing, on the media content recommendation page, media content based on the first media content recommendation stream.

In an optional implementation, the first media content recommendation stream includes target media content, and the playing, on the media content recommendation page, media content based on the first media content recommendation stream includes:
playing the target media content and displaying a preset mark on the media content recommendation page, where the preset mark is used for marking the target media content as being determined based on the recommendation adjustment manner for the recommended content type reflected by the first target media resource object.

In an optional implementation, after the determining a recommendation adjustment manner for a recommended content type reflected by the first target media resource object, the method further includes:
switching the display from the first page to a third page and displaying, on the third page, a correspondence between the recommended content type reflected by the first target media resource object and the recommendation adjustment manner, in response to a trigger operation on a preset control on the first page.

According to a second aspect, the present disclosure provides a data processing apparatus. The apparatus includes:
a display module configured to display, on a first page, a media resource object and a recommendation adjustment control corresponding to the media resource object, where the media resource object is used for reflecting a recommended content type, and the media resource object includes an image or a video segment belonging to the recommended content type; and
a determination module configured to determine, in response to a trigger operation on a recommendation adjustment control corresponding to a first target media resource object, a recommendation adjustment manner for a recommended content type reflected by the first target media resource object, where the recommendation adjustment manner is used for adjusting a recommendation amount for media content of the recommended content type.

According to a third aspect, the present disclosure provides a computer-readable storage medium having instructions stored thereon. The instructions, when executed on a terminal device, cause the terminal device to implement the method described above.

According to a fourth aspect, the present disclosure provides a data processing device. The data processing device includes: a memory, a processor, and a computer program stored on the memory and executable on the processor, wherein the computer program, when executed by the processor, causes the method described above to be implemented.

According to a fifth aspect, the present disclosure provides a computer program product. The computer program product includes a computer program/instructions. The computer program/instructions, when executed by a processor, cause the method described above to be implemented.

Compared with the prior art, the technical solutions provided in the embodiments of the present disclosure have at least the following advantages.

The embodiments of the present disclosure provides a data processing method, in which the media resource object and the recommendation adjustment control corresponding to each media resource object are displayed on the first page first, where the media resource object is used for reflecting a recommended content type, and the media resource object includes an image or a video segment belonging to the recommended content type; and then the recommendation adjustment manner for the recommended content type reflected by the first target media resource object is determined in response to the trigger operation on the recommendation adjustment control corresponding to the first target media resource object, where the recommendation adjustment manner is used for adjusting the recommendation amount for the media content of the recommended content type.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a flowchart of a data processing method according to an embodiment of the present disclosure;

FIG. 2 is a schematic diagram of a first page according to an embodiment of the present disclosure;

FIG. 3 is a schematic diagram of a second page according to an embodiment of the present disclosure;

FIG. 4 is a schematic diagram of a media content recommendation page according to an embodiment of the present disclosure;

FIG. 5 is a schematic diagram of a third page according to an embodiment of the present disclosure;

FIG. 6 is a schematic structural diagram of a data processing apparatus according to an embodiment of the present disclosure; and

FIG. 7 is a schematic structural diagram of a data processing device according to an embodiment of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

Content tags in the form of text cannot intuitively reflect features of recommended content types, resulting in a poor user experience when a user triggers adjustment to the recommendation amount for media content of the recommended content types, and possibly leading to a mismatch between a content recommendation strategy adjusted by the user and the browsing needs of the user for the media content types.

Therefore, the embodiments of the present disclosure provides a data processing method, in which a media resource object and a recommendation adjustment control corresponding to each media resource object are displayed on a first page, where the media resource object is used for reflecting a recommended content type, and the media resource object includes an image or a video segment belonging to the recommended content type; and then a recommendation adjustment manner for a recommended content type reflected by a first target media resource object in at least one media resource object is determined in response to a trigger operation on a recommendation adjustment control corresponding to the first target media resource object, where the recommendation adjustment manner is used for adjusting the recommendation amount for the media content of the recommended content type. It can be seen that in the embodiments of the present disclosure, the user can trigger adjustment to the recommendation amount for media content of a recommended content type based on an image or a video segment that can more intuitively reflect the recommended content type, thereby enriching functions related to content recommendation, meeting the related needs of the user for content recommendation, and improving the user experience.

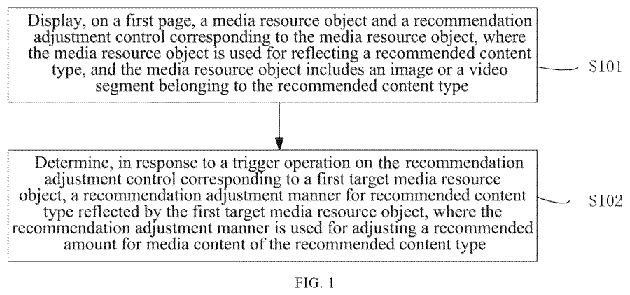

Based on this, an embodiment of the present disclosure provides a data processing method. FIG. 1 is a flowchart of a data processing method according to an embodiment of the present disclosure. The method includes:
S101: Display, on a first page, a media resource object and a recommendation adjustment control corresponding to the media resource object.

The media resource object is used for reflecting a recommended content type, and the media resource object includes an image or a video segment belonging to the recommended content type.

The data processing method according to the embodiment of the present disclosure may be applied to a client. For example, the client may include a client deployed in a smartphone, a client deployed in a tablet computer, etc.

In the embodiment of the present disclosure, the first page may be any page, and one or more media resource objects are displayed on the first page. For example, the first page may be a recommended content adjustment page. It should be noted that, for the first page in the embodiment of the present disclosure, media resource objects are displayed thereon and the media resource objects each have corresponding recommendation adjustment controls, but other features of the first page may not be specifically limited.

In the embodiment of the present disclosure, the media resource object may include an image or a video segment that can reflect a recommended content type, and the media resource object specifically may be an image or a video segment displayed in the form of a card. In the case that the media resource object is a video segment, the video segment can be played on a loop when the media resource object is completely displayed on the first page.

In the embodiment of the present disclosure, each media resource object displayed on the first page is provided with a corresponding recommendation adjustment control for adjustment based on a recommendation amount of media content for a recommended content type reflected by the media resource object.

In an optional implementation, each media resource object may correspond to one recommendation adjustment control, or may correspond to a plurality of recommendation adjustment controls. Assuming that each media resource object corresponds to one recommendation adjustment control, the recommendation adjustment control may be used to perform an adjustment for a recommendation amount increase, an adjustment for a recommendation amount decrease, etc. based on a recommendation amount for media content of the recommended content type reflected by a media resource object corresponding to the media resource object. For example, the recommendation adjustment control may be in the form of a track bar or a slider, and the adjustment for a recommendation amount increase and the adjustment for a recommendation amount decrease can be achieved by moving on the track bar or moving the slider.

Assuming that each media resource object corresponds to a plurality of (for example, two) recommendation adjustment controls, each of the plurality of recommendation adjustment controls may have a corresponding recommendation adjustment manner. For example, a recommendation adjustment control A is used to implement the adjustment for a recommendation amount increase of media content of a recommended content type reflected by the media resource object, and a recommendation adjustment control B is used to implement the adjustment for a recommendation amount decrease of the media content of the recommended content type reflected by the media resource object. In addition, finer-grained adjustment of the recommendation amount may further be achieved by using the recommendation adjustment control corresponding to the media resource object, and the specific manners are not limited in the embodiment of the present disclosure.

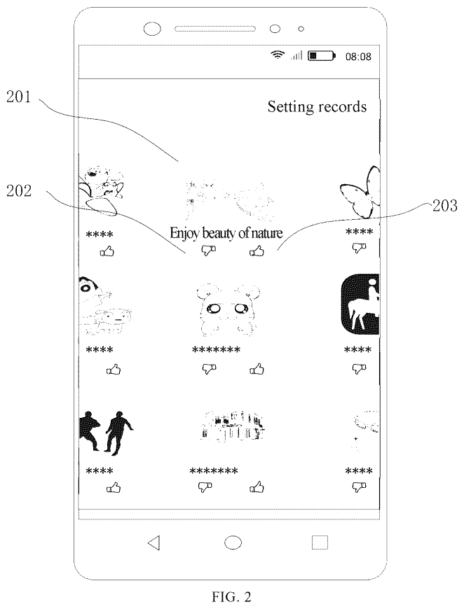

FIG. 2 is a schematic diagram of a first page according to an embodiment of the present disclosure. A plurality of media resource objects and recommended content adjustment controls respectively corresponding to the media resource objects are displayed on the first page. For example, recommended content adjustment controls corresponding to the media resource object 201 include a recommended content adjustment control 202 and a recommended content adjustment control 203. The media resource object may include an image or a video segment that can reflect a recommended content type. In addition, the media resource object may further include a text description and the like that can reflect the recommended content type. For example, the media resource object 201 includes a text description of “Enjoy beauty of nature”.

In addition, as shown in FIG. 2, a display icon of the recommended content adjustment control 202 can indicate that a user is not interested in a recommended content type reflected by the media resource object 201. Therefore, if the user triggers the recommended content adjustment control 202, it indicates that the user wants to reduce the recommendation amount for media content of the recommended content type. In contrast, a display icon of the recommended content adjustment control 203 can indicate that the user is interested in the recommended content type reflected by the media resource object 201. Therefore, if the user triggers the recommended content adjustment control 202, it indicates that the user wants to increase the recommendation amount for the media content of the recommended content type.

In order to reflect that the media resource object 201 has a function of adjusting the recommendation amount for media content of a particular recommended content type, in this embodiment of the present disclosure, the media resource object 201 may be displayed in the style of a stack of cards, so as to prompt the user that the recommendation amount for the media content of this recommended content type can be adjusted based on the media resource object 201.

In an optional implementation, a plurality of media resource objects may be displayed on the first page. Specifically, the plurality of media resource objects may be displayed in the form of a media resource object list, and the media resource list may support sliding display of the plurality of media resource objects.

Specifically, left-and-right sliding display of the media resource objects in the media resource list may be supported. As shown in FIG. 2, the user can have the media resource objects displayed on the first page by swiping the media resource list left and right. In addition, the media resource list may alternatively be a media resource list that can support up-and-down sliding display. Specifically, the user can have the media resource objects displayed on the first page by swiping the media resource list up and down.

In an optional implementation, a display position of each media resource object in the media resource list may be determined based on a degree of association between a media content type reflected by the media resource object and an interest tag of the current user. Optionally, the higher the degree of association with the interest tag of the current user, the more forward the display position of the media resource object in the media resource list. In the media resource list that can support left-and-right sliding as shown in FIG. 2, the higher the degree of association with the interest tag of the current user, the more left the display position of the media resource object in the media resource list.

In another optional implementation, when a plurality of media resource objects are displayed on the first page, three columns of media resource objects may be displayed by default at first, and images of the two columns of media resource objects located at both sides may be partially displayed to prompt the user that the user can trigger the display of more media resource objects by sliding left and right, as shown in FIG. 2.

In actual applications, the plurality of media resource objects displayed on the first page may include a first media resource object and a second media resource object, where a partial image of the first media resource object is displayed on the first page, and an entire image of the second media resource object is displayed on the first page, as shown in FIG. 2.

S102: Determine, in response to a trigger operation on a recommendation adjustment control corresponding to a first target media resource object, a recommendation adjustment manner for a recommended content type reflected by the first target media resource object.

The recommendation adjustment manner is used for adjusting a recommendation amount for media content of the recommended content type.

The first target media resource object may be any media resource object displayed on the first page.

In an optional implementation, assuming that the first target media resource object corresponds to one recommendation adjustment control, the trigger operation on the recommendation adjustment control corresponding to the first target media resource object may include a swipe operation on the recommendation adjustment control, etc., so as to trigger a finer-grained adjustment of the recommendation amount for the media content of the recommended content type reflected by the first target media resource object. For example, a track bar control is used for the finer-grained adjustment of the recommendation amount for the media content of the recommended content type as described above.

Assuming that the first target media resource object corresponds to a plurality of recommendation adjustment controls, the trigger operation on the recommendation adjustment control corresponding to the first target media resource object may include a trigger operation on any one of the plurality of recommendation adjustment controls. In this case, different recommendation adjustment controls correspond to different recommendation adjustment manners, as shown in FIG. 2. By clicking any one of the recommendation adjustment controls, a recommendation adjustment manner for media content of a recommended content type corresponding to the recommendation adjustment control is determined, where there is a correspondence between the recommendation adjustment manner and the recommendation adjustment control. As shown in FIG. 2, after the recommendation adjustment control is clicked, the recommendation adjustment control is displayed in a lit mode to prompt the user that the recommended content type corresponding to the recommendation adjustment control is already adjusted.

In the data processing method according to this embodiment of the present disclosure, the media resource object and the recommendation adjustment control corresponding to each media resource object are displayed on the first page first, where the media resource object is used for reflecting a recommended content type, and the media resource object includes an image or a video segment belonging to the recommended content type; and then the recommendation adjustment manner for the recommended content type reflected by the first target media resource object is determined in response to the trigger operation on the recommendation adjustment control corresponding to the first target media resource object, where the recommendation adjustment manner is used for adjusting the recommendation amount for the media content of the recommended content type. It can be seen that in this embodiment of the present disclosure, the user can trigger adjustment to the recommendation amount for media content of a recommended content type based on an image or a video segment that can reflect the recommended content type, thereby enriching functions related to content recommendation, meeting the related needs of the user for content recommendation, and improving the user experience.

On the basis of the embodiments described above, in order to enable the user to further understand the recommended content type reflected by the media resource object, according to an embodiment of the present disclosure, playback of a video corresponding to the media resource object may be further triggered.

Specifically, a first video corresponding to a second target media resource object on the first page is played within a video playback window on a second page in response to a trigger operation on the second target media resource object. The second target media resource object may be any media resource object displayed on the first page. The second target media resource object and the first target media resource object may be a same media resource object, or may be different media resource objects.

The second target media resource object includes an image or a video segment determined from the first video. For example, the second target media resource object may be a cover of the first video, etc., or the second target media resource object is an image, a video segment, etc. that can reflect a recommended content type corresponding to the second target media resource object.

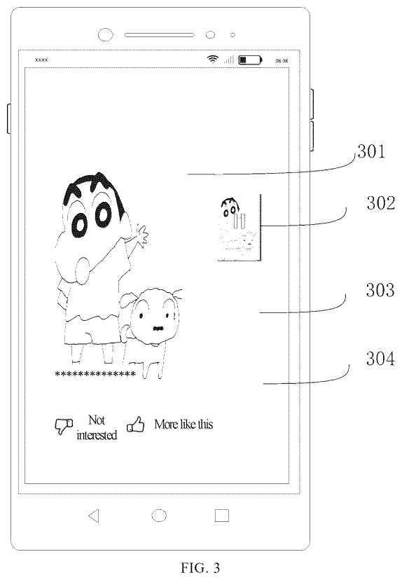

FIG. 3 is a schematic diagram of a second page according to an embodiment of the present disclosure. After the trigger operation on the second target media resource object on the first page is received, the first video corresponding to the second target media resource object is played within a video playback window 301 on the second page. The second target media resource object is an image or a video segment determined from the first video.

In order to improve the convenience of adjustment of the recommendation amount for the recommended content type reflected by the second target media resource object, a recommendation adjustment control corresponding to the second target media resource object may be displayed on the second page. When the trigger operation on the recommendation adjustment control corresponding to the second target media resource object is received, a recommendation adjustment manner for the recommended content type reflected by the second target media resource object may be determined to achieve the adjustment of the recommendation amount for media content of the recommended content type.

In an optional implementation, in order to further facilitate the understanding of the recommended content type reflected by the second target media resource object, in addition to the video cover of the first video, video covers of a plurality of second videos may also be displayed on the second page, where the plurality of second videos all belong to the recommended content type reflected by the second target media resource object.

Specifically, a target video of the plurality of second videos is played within the video playback window 301 on the second page in response to a trigger operation on a video cover of the target video. The user can further understand the corresponding recommended content type through the target video.

As shown in FIG. 3, the video cover of the first video and the video covers of the plurality of second videos, such as a video cover 302 of the first video and video covers 303 and 304 of the second videos, are displayed on the second page. The second videos respectively corresponding to the video covers 303 and 304 of the second videos both belong to the recommended content type reflected by the second target media resource object.

As shown in FIG. 3, in response to a trigger operation on the video cover of the second video 303, the video currently played within the video playback window 301 on the second page is switched to the second video 303.

In the embodiments of the present disclosure, after adjustment of the recommendation amount for media content of a recommended content type reflected by any one or more media resource objects is completed, a media content recommendation page may be entered again for browsing recommended media content.

In an optional implementation, when the media content recommendation page is entered again, a refresh operation on a media content recommendation stream may be triggered. Specifically, when a display trigger operation on the media content recommendation page is received, a first media content recommendation stream is obtained. The first media content recommendation stream is recommended based on an updated recommendation strategy, where the updated recommendation strategy is obtained by updating an original recommendation strategy based on the adjustment operation described above. After the first media content recommendation stream is obtained, media content is played on the media content recommendation page based on the first media content recommendation stream.

In an optional implementation, in order to prompt the user that the currently played media content is recommended based on the updated recommendation strategy that is obtained based on the adjustment for the recommended content type, according to an embodiment of the present disclosure, a preset mark may be displayed on the media content recommendation page during playing of target media content on the media content recommendation page, where the preset mark is used for marking the played target media content as being determined based on the recommendation adjustment manner for the recommended content type reflected by the first target media resource object.

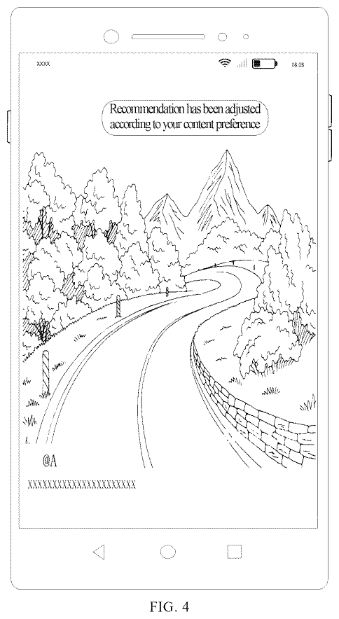

FIG. 4 is a schematic diagram of a media content recommendation page according to an embodiment of the present disclosure. On the media content recommendation page, target media content is played while displaying a preset mark “Recommendation has been adjusted according to your content preference”.

On the basis of the embodiments described above, in order to facilitate the user to understand the recommendation adjustment manner for each recommended content type, according to an embodiment of the present disclosure, after the recommendation adjustment manner for the recommended content type reflected by the first target media resource object is determined, the display may be switched from the first page to a third page and a correspondence between the recommended content type reflected by the first target media resource object and the recommendation adjustment manner may be displayed on the third page, in response to a trigger operation on a preset control on the first page.

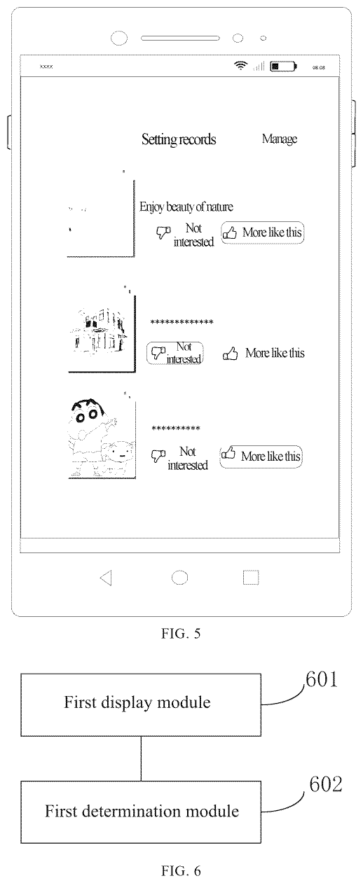

FIG. 5 is a schematic diagram of a third page according to an embodiment of the present disclosure. On the third page, adjustment records of a current user for recommended content types, specifically including correspondences between adjusted recommended content types and recommendation adjustment manners, are displayed.

In an optional implementation, on the third page, the correspondence between the recommended content types and the recommendation adjustment manners may be managed. For example, an operation such as modification or deletion may be triggered for a correspondence relationship between any one or more recommended content types and recommendation adjustment manners, so as to update the correspondences between the recommended content types and the recommendation adjustment manners, thereby achieving adjustment of the recommendation amount for media content of the recommended content types. In addition, clearing of setting records may be triggered on the third page, thereby restoring a default recommendation strategy.

Based on the method embodiment described above, the present disclosure further provides a data processing apparatus. FIG. 6 is a schematic structural diagram of a data processing apparatus according to an embodiment of the present disclosure. The apparatus includes:
a first display module 601 configured to display, on a first page, a media resource object and a recommendation adjustment control corresponding to the media resource object, where the media resource object is used for reflecting a recommended content type, and the media resource object includes an image or a video segment belonging to the recommended content type; and
a first determination module 602 configured to determine, in response to a trigger operation on a recommendation adjustment control corresponding to a first target media resource object, a recommendation adjustment manner for a recommended content type reflected by the first target media resource object, where the recommendation adjustment manner is used for adjusting the recommendation amount for the media content of the recommended content type.

In an optional implementation, the apparatus further includes:
a first playing module configured to play a first video corresponding to a second target media resource object within a video playback window on a second page in response to a trigger operation on the second target media resource object, where the second target media resource object is an image or a video segment determined from the first video.

In an optional implementation, the apparatus further includes:
a second display module configured to display, on the second page, a recommendation adjustment control corresponding to the second target media resource object; and
a first determination module configured to determine, in response to a trigger operation on a recommendation adjustment control corresponding to the second target media resource object, a recommendation adjustment manner for a recommended content type reflected by the second target media resource object.

In an optional implementation, the apparatus further includes:
a third display module configured to display, on the second page, a video cover of the first video and video covers of a plurality of second videos, where the plurality of second videos belong to the recommended content type reflected by the second target media resource object; and
a second playing module configured to play a target video of the plurality of second videos within the video playback window on the second page in response to a trigger operation on a video cover of the target video.

In an optional implementation, the first display module is specifically configured to:
display a media resource object list on the first page, where the media resource object list includes a plurality of media resource objects, the plurality of media resource objects respectively have corresponding recommendation adjustment controls, and the media resource list supports sliding display of the plurality of media resource objects.

In an optional implementation, a display position of the media resource object in the media resource object list is determined based on a degree of association between a recommended content type reflected by the media resource object and an interest tag of a current user.

In an optional implementation, the plurality of media resource objects include a first media resource object and a second media resource object, and the first display module is specifically configured to:
display, on the first page, a partial image of the first media resource object and an entire image of the second media resource object.

In an optional implementation, the apparatus further includes:
a first obtaining module configured to obtain a first media content recommendation stream in response to a display trigger operation on a media content recommendation page, where the first media content recommendation stream is recommended based on an updated recommendation strategy, and the updated recommendation strategy is updated according to the recommendation adjustment manner for the recommended content type reflected by the first target media resource object; and
a third playing module configured to play, on the media content recommendation page, media content based on the first media content recommendation stream.

In an optional implementation, the first media content recommendation stream includes target media content, and the third playing module is specifically configured to:
play the target media content and display a preset mark on the media content recommendation page, where the preset mark is used for marking the target media content as being determined based on the recommendation adjustment manner for the recommended content type reflected by the first target media resource object.

In an optional implementation, the apparatus further includes:
a fourth display module configured to switch the display from the first page to a third page and display, on the third page, a correspondence between the recommended content type reflected by the first target media resource object and the recommendation adjustment manner, in response to a trigger operation on a preset control on the first page.

In the data processing apparatus according to this embodiment of the present disclosure, the media resource object and the recommendation adjustment control corresponding to each media resource object are displayed on the first page first, where the media resource object is used for reflecting a recommended content type, and the media resource object includes an image or a video segment belonging to the recommended content type; and then the recommendation adjustment manner for the recommended content type reflected by the first target media resource object is determined in response to the trigger operation on the recommendation adjustment control corresponding to the first target media resource object, where the recommendation adjustment manner is used for adjusting the recommendation amount for the media content of the recommended content type. It can be seen that in this embodiment of the present disclosure, the user can trigger adjustment to the recommendation amount for media content of a recommended content type based on an images or a video segment that can reflect the recommended content type, thereby enriching functions related to content recommendation, meeting the related needs of the user for content recommendation, and improving the user experience.

In addition to the method and apparatus described above, an embodiment of the present disclosure further provides a computer-readable storage medium having instructions stored thereon. The instructions, when executed on a terminal device, cause the terminal device to implement the data processing method described in the embodiment of the present disclosure.

An embodiment of the present disclosure further provides a computer program product. The computer program product includes a computer program or instructions. When the computer program or instructions, when executed by a processor, cause the data processing method described in the embodiment of the present disclosure to be implemented.

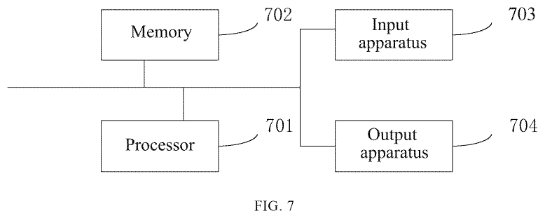

In addition, an embodiment of the present disclosure further provides a data processing device. As shown in FIG. 7, the data processing device may include:
a processor 701, a memory 702, an input apparatus 703, and an output apparatus 704. There may be one or more processors 701 in the data processing device. For example, there is one processor in FIG. 7. In some embodiments of the present disclosure, the processor 701, the memory 702, the input apparatus 703, and the output apparatus 704 may be connected through a bus or in another manner, for example, are connected through the bus in FIG. 7.

The memory 702 may be configured to store a software program and a module. The processor 701 performs various functional applications of the data processing device and processes data by executing the software program and the module stored in the memory 702. The memory 702 may mainly include a program storage area and a data storage area, where the program storage area may have an operating system, an application required by at least one function, and the like stored therein. In addition, the memory 702 may include a high-speed random-access memory, and may further include a non-volatile memory, such as at least one magnetic disk storage device, a flash memory device, or other volatile solid-state storage devices. The input apparatus 703 may be configured to receive input numerical or character information, and generate a signal input related to a user setting and function control of the data processing device.

Specifically, in this embodiment, the processor 701 loads an executable file corresponding to a process of one or more applications into the memory 702 in accordance with the following instructions, and the processor 701 executes the application stored in the memory 702, to implement various functions of the data processing device described above.

It should be noted that the relational terms such as “first” and “second” herein are only used to distinguish one entity or operation from another, and do not necessarily require or imply that any actual relationship or sequence exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

1. A data processing method, comprising:
displaying, on a first page, a media resource object and a recommendation adjustment control corresponding to the media resource object, wherein the media resource object is used for reflecting a recommended content type, and the media resource object comprises an image or a video segment belonging to the recommended content type; and
determining, in response to a trigger operation on the recommendation adjustment control corresponding to a first target media resource object, a recommendation adjustment manner for the recommended content type reflected by the first target media resource object, wherein the recommendation adjustment manner is used for adjusting a recommendation amount for media content of the recommended content type.

2. The method according to claim 1, further comprising:
playing a first video corresponding to a second target media resource object within a video playback window on a second page in response to a trigger operation on the second target media resource object, wherein the second target media resource object is an image or a video segment determined from the first video.

3. The method according to claim 2, further comprising:
displaying, on the second page, a recommendation adjustment control corresponding to the second target media resource object; and
determining, in response to a trigger operation on the recommendation adjustment control corresponding to the second target media resource object, a recommendation adjustment manner for a recommended content type reflected by the second target media resource object.

4. The method according to claim 2, further comprising:
displaying, on the second page, a video cover of the first video and video covers of a plurality of second videos, wherein the plurality of second videos belong to the recommended content type reflected by the second target media resource object; and
playing a target video of plurality of second videos within the video playback window on the second page in response to a trigger operation on a video cover of the target video.

5. The method according to claim 1, wherein displaying, on the first page, the media resource object and the recommendation adjustment control corresponding to the media resource object comprises:
displaying a media resource object list on the first page, wherein the media resource object list comprises a plurality of media resource objects, the plurality of media resource objects respectively have corresponding recommendation adjustment controls, and the media resource list supports sliding display of the plurality of media resource objects.

6. The method according to claim 5, wherein a display position of the media resource object in the media resource object list is determined based on a degree of association between a recommended content type reflected by the media resource object and an interest tag of a current user.

7. The method according to claim 5, wherein the plurality of media resource objects comprise a first media resource object and a second media resource object, and displaying the media resource object list on the first page comprises:
displaying, on the first page, a partial image of the first media resource object and an entire image of the second media resource object.

8. The method according to claim 1, wherein after determining the recommendation adjustment manner for the recommended content type reflected by the first target media resource object, the method further comprises:
obtaining a first media content recommendation stream in response to a display trigger operation on a media content recommendation page, wherein the first media content recommendation stream is recommended based on an updated recommendation strategy, and the updated recommendation strategy is updated by using the recommendation adjustment manner for the recommended content type reflected by the first target media resource object; and
playing, on the media content recommendation page, media content based on the first media content recommendation stream.

9. The method according to claim 8, wherein the first media content recommendation stream comprises target media content, and playing, on the media content recommendation page, the media content based on the first media content recommendation stream comprises:
playing the target media content and displaying a preset mark on the media content recommendation page, wherein the preset mark is used for marking the target media content as being determined based on the recommendation adjustment manner for the recommended content type reflected by the first target media resource object.

10. The method according to claim 1, wherein after determining the recommendation adjustment manner for the recommended content type reflected by the first target media resource object, the method further comprises:
switching display from the first page to a third page and displaying, on the third page, a correspondence between the recommended content type reflected by the first target media resource object and the recommendation adjustment manner, in response to a trigger operation on a preset control on the first page.

11. (canceled)

12. A non-transitory computer-readable storage medium having instructions stored thereon, wherein the instructions, when executed on a terminal device, cause the terminal device to:
display, on a first page, a media resource object and a recommendation adjustment control corresponding to the media resource object, wherein the media resource object is used for reflecting a recommended content type, and the media resource object comprises an image or a video segment belonging to the recommended content type; and
determine, in response to a trigger operation on the recommendation adjustment control corresponding to a first target media resource object, a recommendation adjustment manner for the recommended content type reflected by the first target media resource object, wherein the recommendation adjustment manner is used for adjusting a recommendation amount for media content of the recommended content type.

13. A data processing device, comprising: a memory, a processor, and a computer program stored on the memory and executable on the processor, wherein the computer program, when executed by the processor, causes the processor to:
display, on a first page, a media resource object and a recommendation adjustment control corresponding to the media resource object, wherein the media resource object is used for reflecting a recommended content type, and the media resource object comprises an image or a video segment belonging to the recommended content type; and
determine, in response to a trigger operation on the recommendation adjustment control corresponding to a first target media resource object, a recommendation adjustment manner for the recommended content type reflected by the first target media resource object, wherein the recommendation adjustment manner is used for adjusting a recommendation amount for media content of the recommended content type.

14. The non-transitory computer-readable storage medium according to claim 12, the instructions further cause the terminal device to:
play a first video corresponding to a second target media resource object within a video playback window on a second page in response to a trigger operation on the second target media resource object, wherein the second target media resource object is an image or a video segment determined from the first video.

15. The non-transitory computer-readable storage medium according to claim 14, the instructions further cause the terminal device to:
display, on the second page, a recommendation adjustment control corresponding to the second target media resource object; and
determine, in response to a trigger operation on the recommendation adjustment control corresponding to the second target media resource object, a recommendation adjustment manner for a recommended content type reflected by the second target media resource object.

16. The non-transitory computer-readable storage medium according to claim 14, the instructions further cause the terminal device to:
display, on the second page, a video cover of the first video and video covers of a plurality of second videos, wherein the plurality of second videos belong to the recommended content type reflected by the second target media resource object; and
play a target video of plurality of second videos within the video playback window on the second page in response to a trigger operation on a video cover of the target video.

17. The non-transitory computer-readable storage medium according to claim 12, wherein the instructions causing the terminal device to display, on the first page, the media resource object and the recommendation adjustment control corresponding to the media resource object further cause the terminal device to:
display a media resource object list on the first page, wherein the media resource object list comprises a plurality of media resource objects, the plurality of media resource objects respectively have corresponding recommendation adjustment controls, and the media resource list supports sliding display of the plurality of media resource objects.

18. The non-transitory computer-readable storage medium according to claim 17, wherein a display position of the media resource object in the media resource object list is determined based on a degree of association between a recommended content type reflected by the media resource object and an interest tag of a current user.

19. The non-transitory computer-readable storage medium according to claim 17, wherein the plurality of media resource objects comprise a first media resource object and a second media resource object, and the instructions causing the terminal device to display the media resource object list on the first page further cause the terminal device to:
display, on the first page, a partial image of the first media resource object and an entire image of the second media resource object.

20. The non-transitory computer-readable storage medium according to claim 12, wherein after the instructions causing the terminal device to determine the recommendation adjustment manner for the recommended content type reflected by the first target media resource object, the instructions further cause the terminal device to:
obtain a first media content recommendation stream in response to a display trigger operation on a media content recommendation page, wherein the first media content recommendation stream is recommended based on an updated recommendation strategy, and the updated recommendation strategy is updated by using the recommendation adjustment manner for the recommended content type reflected by the first target media resource object; and
play, on the media content recommendation page, media content based on the first media content recommendation stream.

21. The non-transitory computer-readable storage medium according to claim 20, wherein the first media content recommendation stream comprises target media content, and the instructions causing the terminal device to play, on the media content recommendation page, the media content based on the first media content recommendation stream cause the terminal device to:
play the target media content and display a preset mark on the media content recommendation page, wherein the preset mark is used for marking the target media content as being determined based on the recommendation adjustment manner for the recommended content type reflected by the first target media resource object.
